(19) United States
(12) Patent Application Publication
(10) Pub. No.: US 2026/0358461 A1
(43) Pub. Date: Nov. 12, 2026

(54) Devices and Methods for Setting Out Features of a Construction Site

(71) Applicant: 3D Technologies LTD, Warwick (GB)

(72) Inventors: Alan Rock, Warwick (GB); Eduard Kriegler, Warwick (GB); Trevor Tapping, Warwick (GB)

(21) Appl. No.: 19/475,026

(22) PCT Filed: Apr. 12, 2024
(86) PCT No.: PCT/EP2024/059996

§ 371 Date: Oct. 13, 2025

(30) Foreign Application Priority Data
Apr. 14, 2023 (GB) 2305518.9

(51) Int. Cl. G01S 5/02; G06Q 50/08

(52) U.S. Cl. CPC G01S 5/0284; G06Q 50/08

(57) ABSTRACT

Techniques relate to identifying a location for positioning a feature of a structure. For example, a system can include a measuring device including a plurality of motion sensors configured to obtain data representing position and/or orientation. The system can also include a processor configured to determine an origin point at a first location at which the measuring device is placed and determine, based on stored data relating to the structure, a location for positioning a feature of the structure relative to the origin point. Further, the processor can be configured to determine a location of the measuring device relative to the origin point, compare the location of the measuring device with the location for positioning the feature of the structure, and determine a difference between the location of the measuring device and the location for positioning the feature of the structure.

### RELATED APPLICATIONS

This application is the 35 U.S.C. § 371 National Phase of International App. No. PCT/EP2024/059996, filed on Apr. 12, 2024, which claims priority to GB Patent App. No. 2305518.9, filed on Apr. 14, 2023, both of which are incorporated by reference herein in their entirety.

### TECHNICAL FIELD

The invention relates to identifying locations and/or measuring dimensions when setting out a structure or other feature on a construction site. In particular, the invention may relate to, but need not be limited to, identifying features of a structure that has not yet been built.

### BACKGROUND

When building a new structure, such as a building, road, landscaped area or any related services structure, the location of features of the structure must be set out on the construction site to allow works to be undertaken correctly and for the structure to be correctly positioned and oriented. Also, in some scenarios, features of existing structures that are hidden from view, such as underground pipes, cabling or junction boxes may need to be located and identified at surface level.

Traditional techniques for setting out the location features of such structures include using a tape measure and a set square. In such circumstances, an origin point is established, e.g. at a corner of a building, and a datum line taken from the origin point, e.g. along a wall of the building. Dimensions of the structure are read from a printed plan and two construction workers measure distances and angles from the origin point and/or datum line to establish the location of the features of the building. Errors using such techniques are common and sometimes large. Also, the process is time consuming and requires two people.

In other known arrangements, a total station may be used to set out features of a structure. However, a total station is an expensive piece of surveying equipment requiring significant skill and experience to operate and is not suitable for the majority of smaller construction projects.

There is a need for an accurate, cost-effective method for setting out features of a structure on a construction site that can be implemented by any construction worker without significant training or experience.

### SUMMARY

Methods and apparatus disclosed herein are directed to solving one or more problems in the prior art, including those disclosed herein.

According to the invention in an aspect, there is provided a construction site setting out tool for identifying a location at which a feature of an unbuilt and/or unseen structure should be positioned, the tool comprising: a measuring device including a plurality of motion sensors configured to obtain data representing position and orientation based on rotational and linear movement of the measuring device in a body frame comprising orthogonal x, y and z axes; and a computer processor configured to: determine an origin point at a first location at which the measuring device is placed; determine, based on stored data relating to the structure, the location at which the feature of the structure should be positioned relative to the origin point; determine a location of the measuring device relative to the origin point based on the obtained data representing position and orientation; compare the location of the measuring device with the location at which the feature of the structure should be positioned; and determine a difference between the location of the measuring device and the location at which the feature of the structure should be positioned.

Optionally, the computer processor is further configured to determine a datum line extending in a datum direction from the origin point, and wherein the location at which the feature of the structure should be positioned is also relative to the datum line.

Optionally, the computer processor is further configured to determine the datum direction based on a second location at which the measuring device is placed.

Optionally, the tool further comprises providing an indication to a user based on the determined difference, and optionally wherein providing the indication comprises providing a guidance direction indicating a direction from the measuring device to the location at which the feature of the structure should be positioned.

Optionally, providing an indication comprises providing a guidance distance indicating a distance from the measuring device to the location at which the feature of the structure should be positioned.

Optionally, the stored data comprises data representing a blueprint of the structure.

Optionally, the stored data comprises one or more predefined shapes, and wherein the computer processor is further configured to receive one or more dimensions of a predefined shape from a user.

Optionally, the tool further comprises a user interface configured to permit a user to select one of a plurality of locations of features of the structure, and wherein determining the location at which the feature of the structure should be positioned relative to the origin point is based on the selected location.

Optionally, wherein the measuring device further comprises a reference point, and wherein the provided indications are based on a difference between the reference point and the location at which the feature of the structure should be positioned.

Optionally, wherein the computer processor is included in a processing device, separate to the measuring device, and wherein the measuring device comprises a transmitter configured to transmit the obtained data representing position and orientation, and the processing device comprises a receiver configured to receive the transmitted data.

According to the invention in an aspect, there is provided a method of identifying a location at which a feature of an unbuilt and/or unseen structure should be positioned, the method comprising: obtaining data representing position and orientation using a measuring device including a plurality of motion sensors configured to measure rotational and linear movement of the measuring device in a body frame comprising orthogonal x, y and z axes; determining an origin point at a first location at which the measuring device is placed; determining, based on stored data relating to the structure, the location at which the feature of the structure should be positioned relative to the origin point; determining a location of the measuring device relative to the origin point based on the obtained data representing position and orientation; comparing the location of the measuring device with the location at which the feature of the structure should be positioned; and determining a difference between the location of the measuring device and the location at which the feature of the structure should be positioned.

According to the invention in an aspect, there is provided a processing device for identifying a location at which a feature of an unbuilt and/or unseen structure should be positioned, the processing device comprising: a receiver configured to receive obtained data representing position and orientation transmitted by a measuring device; and a computer processor configured to: determine an origin point at a first location at which the measuring device is placed; determine, based on stored data relating to the structure, the location at which the feature of the structure should be positioned relative to the origin point; determine a location of the measuring device relative to the origin point based on the obtained data relating to position and orientation; compare the location of the measuring device with the location at which the feature of the structure should be positioned; and determine a difference between the location of the measuring device and the location at which the feature of the structure should be positioned.

According to the invention in an aspect, there is provided a method of identifying a location at which a feature of an unbuilt or unseen structure is to be positioned, the method comprising: receiving, by a receiver, obtained data representing position and orientation transmitted by a measuring device; determining an origin point at a first location at which the measuring device is placed; determining, based on stored data relating to the unbuilt structure, the location at which the feature of the structure should be positioned relative to the origin point; determining a location of the measuring device relative to the origin point based on the obtained data relating to position and orientation; comparing the location of the measuring device with the location at which the feature of the structure should be positioned; and determining a difference between the location of the measuring device and the location at which the feature of the structure should be positioned.

According to the invention in an aspect, there are provided computer program products including computer program code configured, when executed on a computer processor, to control a data processor to undertake the steps of any method described herein.

According to the invention in an aspect, there is provided a construction site setting out tool for identifying a location at which a feature of an unbuilt and/or unseen structure should be positioned, the tool comprising: a measuring device including a plurality of motion sensors configured to obtain data representing position and orientation based on rotational and linear movement of the measuring device in a body frame comprising orthogonal x, y and z axes; and a computer processor configured to: obtain data from the motion sensors when the measurement device is placed at a first location; determine, based on the motion data, a position and/or orientation of the measuring device at the first location, and to determine an origin point at the first location; determine, based on stored data relating to the structure, the location at which the feature of the structure should be positioned relative to the origin point; obtain further data from the motion sensors; determine, based on the further data, a further position and/or orientation of the measuring device relative to the origin point; compare the further position and/or orientation of the measuring device with the determined location at which the feature of the structure should be positioned; and determine a difference between the further position and/or orientation location of the measuring device and the determined location at which the feature of the structure should be positioned.

According to the invention in an aspect, there is provided a method of identifying a location at which a feature of an unbuilt and/or unseen structure should be positioned, the tool comprising a measuring device including a plurality of motion sensors configured to obtain data representing position and orientation based on rotational and linear movement of the measuring device in a body frame comprising orthogonal x, y and z axes, the method comprising: obtaining data from the motion sensors when the measurement device is placed at a first location; determining, based on stored data relating to the structure, the location at which the feature of the structure should be positioned relative to the origin point; obtaining further data from the motion sensors; determining, based on the further data, a further position and/or orientation of the measuring device relative to the origin point; comparing the further position and/or orientation of the measuring device with the determined location at which the feature of the structure should be positioned; and determining a difference between the further position and/or orientation location of the measuring device and the determined location at which the feature of the structure should be positioned.

According to the invention in an aspect, there is provided a processing device for identifying a location at which a feature of an unbuilt and/or unseen structure should be positioned, the processing device comprising: a receiver configured to receive data representing position and/orientation transmitted by a measuring device including a plurality of motion sensors configured to obtain data representing position and orientation based on rotational and linear movement of the measuring device in a body frame comprising orthogonal x, y and z axes; and a computer processor configured to: determine, based on the motion data, a position and/or orientation of the measuring device at the first location, and to determine an origin point at the first location; determine, based on stored data relating to the structure, the location at which the feature of the structure should be positioned relative to the origin point; obtain further data from the motion sensors; determine, based on the further data, a further position and/or orientation of the measuring device relative to the origin point; compare the further position and/or orientation of the measuring device with the determined location at which the feature of the structure should be positioned; and determine a difference between the further position and/or orientation location of the measuring device and the determined location at which the feature of the structure should be positioned.

According to the invention in an aspect, there is provided a method of identifying a location at which a feature of an unbuilt or unseen structure is to be positioned, the method comprising: receiving, by a receiver, data representing position and/orientation transmitted by a measuring device including a plurality of motion sensors configured to obtain data representing position and orientation based on rotational and linear movement of the measuring device in a body frame comprising orthogonal x, y and z axes; determining, based on stored data relating to the structure, the location at which the feature of the structure should be positioned relative to the origin point; obtaining further data from the motion sensors; determining, based on the further data, a further position and/or orientation of the measuring device relative to the origin point; comparing the further position and/or orientation of the measuring device with the determined location at which the feature of the structure should be positioned; and determining a difference between the further position and/or orientation location of the measuring device and the determined location at which the feature of the structure should be positioned.

Optionally, in methods and apparatus disclosed herein, the position of the first location is known in a coordinate reference system, and the data relating to the structure is defined in the same coordinate reference system or in a further coordinate reference system that is transformable to the coordinate reference system.

Optionally, in methods and apparatus disclosed herein, the processor is configured to determine the position and/or orientation of the measuring device at the first location using the obtained motion data, and optionally using only the obtained motion data.

Optionally, in methods and apparatus disclosed herein, the processor is configured to determine the further position and/or orientation of the measuring device using the obtained motion data, and optionally using only the obtained motion data.

### BRIEF DESCRIPTION OF THE DRAWINGS

Embodiments of the disclosed methods and apparatus will be described in detail below, with reference to the accompanying drawings, in which:

FIG. 1 is a schematic representation of a system for setting out features of a structure;

FIG. 2 is a schematic representation of a measuring device;

FIG. 3 is a schematic representation of a processing device;

FIG. 4 is a plan of a ground floor of a building; and

FIG. 5 is a flow diagram showing a method of identifying a location of a feature of an unbuilt structure.

### DETAILED DESCRIPTION

Generally, disclosed herein are methods and apparatus for setting out a location of a feature of a structure, such as a building, landscaped area and/or a hidden (e.g. underground) feature of a structure on a construction site. A measuring device may determine its location relative to an origin point and compare that location to a location of a feature of the structure to be set out. An indication is presented to the construction worker when the measuring device is correctly positioned at the desired location.

A feature of a structure may include a corner of a building or other structure, a wall or location along a wall, a wall opening, such as a door, window or gate, an underground pipe, duct or cable and/or part of a perimeter of an area, such as a path or patio. The term “feature of a structure” is used during the remainder of this detailed description but it will be understood that this need not be limiting and the methods and apparatus disclosed herein may be used to set out the location of any feature or position required when undertaking a construction project.

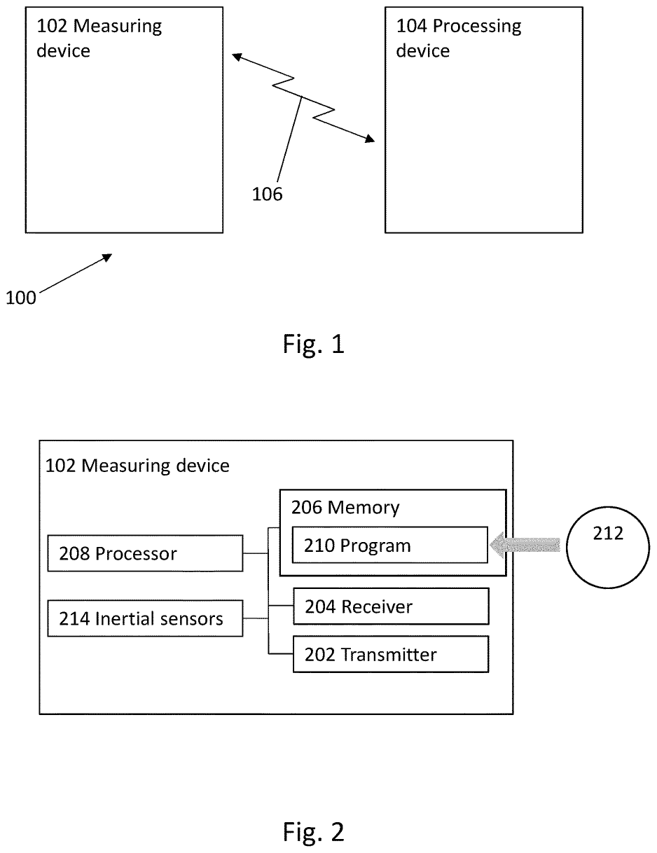

FIG. 1 shows a schematic representation of an exemplary system 100 for setting out the location of features of a structure. The system 100 comprises a measuring device 102 and a processing device 104. Detailed descriptions of exemplary measuring and processing devices 102, 104 are given below. Broadly, the measuring device 102 comprises a plurality of sensors arranged to obtain measured data representing its position and/or orientation. For example, the plurality of sensors may be configured to record linear accelerations and rotational velocities. The measuring device 102 is configured to transmit data representing the position and orientation to the processing device 104. The processing device 104 includes a memory for storing a position of one or more features of a structure, and a processor for comparing the measured position of the measuring device 102 to the position of the one or more features of the structure. The processing device 104 is configured to present an indication to a construction worker expressing an error in the position of the measuring device relative to the position of the one or more features of the structure.

It will be appreciated that at least part of the processing of the data representing the measurements may be undertaken at the measuring device 102 before transmission to the processing device 104. It will also be appreciated that the processing device 104 may form part of the measuring device 102 and they may be housed within a single unit.

In exemplary arrangements, the measuring device 102 may be a hand-held, portable unit suitable for being carried by a construction worker. In exemplary arrangements, the processing device 104 may be a portable processing device, such as a mobile phone, tablet or laptop computer.

The transmission of data from the measuring device 102 to the processing device 104 is shown in FIG. 1 as a wireless transmission 106. The wireless transmission may be a radio frequency transmission using known hardware and communications protocols, such as Bluetooth (RTM), near field communication, Wi-Fi, network-based communications (e.g. the internet) or mobile telecommunications protocols. The wireless transmission 106 may also use optical transmission hardware and protocols. The transmission may be at least partially wired. The processing device 104 may also transmit data to the measuring device 102 via the same, or a different, communications medium and/or protocol.

The transmission of data may be substantially in real time. For example, measurements may be recorded and data representing those measurements transmitted as soon as possible thereafter, e.g. on an open communications link. In some arrangements, the transmission of data may be intermittent and/or from time-to-time. For example, the measuring device may record a plurality of measurements and store data representing the plurality of measurements for transmission at a later time. In such arrangements, the transmission may be triggered manually, or may be triggered by the measuring device 102 detecting an open communication channel (either direct or indirect) to the processing device 104.

FIG. 2 shows a schematic representation of a measuring device 102, which may be the measuring device 102 in FIG. 1. The measuring device 102 comprises a transmitter 202 and, optionally, a receiver 204. The transmitter 202 and receiver 204 may be in data communication with other entities, such as the processing device 104 or servers and/or functions in a telecommunications network, and are configured to transmit and receive data accordingly.

The measuring device 102 further comprises a memory 206 and a processor 208. The memory 206 may comprise a non-volatile memory and/or a volatile memory. The memory 206 may have a computer program 210 stored therein. The computer program 210 may be configured to undertake the methods disclosed herein. The computer program 210 may be loaded in the memory 206 from a non-transitory computer readable medium 212, on which the computer program is stored. The measuring device 102 may also comprise motion (e.g. inertial) sensors 214. The processor 208 is configured to undertake one or more of the functions necessary for operation of one or more of the remaining elements of the measuring device 102.

The inertial sensors 214 may comprise accelerometers and/or rate gyros. The inertial sensors 214 may be arranged to measure acceleration and rotational velocity of the measuring device 102 in three orthogonal axes, typically identified as x-axis, y-axis and z-axis. The accelerations and rotational velocities may be recorded in a body frame (i.e. a frame fixed in relation to the measuring device 102 and defined by x, y and z axes) and converted to any other reference frame (e.g. a local reference frame based on the construction site and/or the layout of an unbuilt structure) using well known techniques. The inertial sensors 214 may form part of an Inertial Measurement Unit (IMU) housed within the measuring device 102. The inertial sensors 214 may incorporate micro-electro-mechanical systems (MEMS) technology.

Throughout this document, inertial sensors are referred to, although it should be understood that other motion sensors may be employed. Such motion sensors include any sensor that is able to detect rotational and/or linear movement of the measuring device 102.

Each of the transmitter 202 and receiver 204, memory 206, processor 208 and inertial sensors 214 is in data communication with the other features of the measuring device 102. The measuring device 102 can be implemented as a combination of hardware and software. In particular, software may be configured to run on the processor 208. The memory 206 stores the various programs/executable files that are implemented by the processor 208, and also provides a storage unit for any required data.

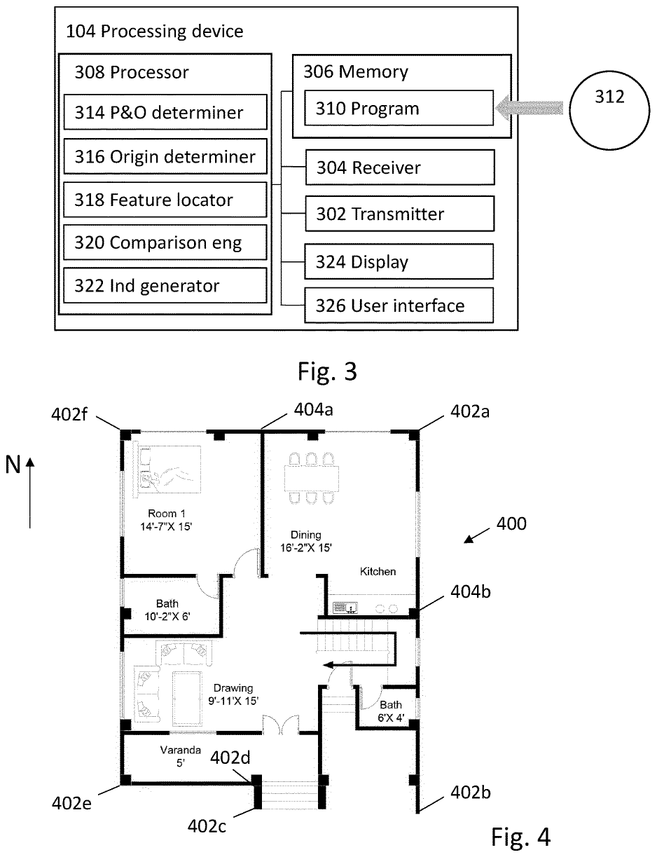

FIG. 3 shows a schematic representation of a processing device 104, which may be the processing device 104 in FIG. 1. The processing device 104 comprises a receiver 304 and optionally a transmitter 302. The transmitter 302 and receiver 304 may be in data communication with other entities, such as measuring device 102 or servers and/or functions in a telecommunications network, and are configured to transmit and receive data accordingly.

The processing device 104 further comprises a memory 306 and a processor 308. The memory 306 may comprise a non-volatile memory and/or a volatile memory. The memory 306 may have a computer program 310 stored therein. The computer program 310 may be configured to undertake the methods disclosed herein. The computer program 310 may be loaded in the memory 306 from a non-transitory computer readable medium 312, on which the computer program 310 is stored. The processor 308 is configured to undertake the functions of a position and orientation processor 314, an origin determiner 316, a feature locator 318, a comparison engine 320 and an indication generator 322, as set out below. The processing device 104 also optionally comprises a display 324 and a user interface 326.

Each of the transmitter 302 and receiver 304, memory 306, processor 308, display 324 and user interface 326 is in data communication with the other features of the processing device 104. The processing device 104 can be implemented as a combination of hardware and software. In particular, the position and orientation processor 314, origin determiner 316, feature locator 318, comparison engine 320 and indication generator 322 may be implemented as software configured to run on the processor 308. The memory 306 stores the various programs/executable files that are implemented by the processor 308, and also provides a storage unit for any required data. The programs/executable files stored in the memory 306, and implemented by the processor 308, can include the position and orientation processor 314, origin determiner 316, feature locator 318, comparison engine 320 and indication generator 322, but are not limited to such.

FIG. 4 shows a blueprint or plan for a ground floor of an unbuilt building 400. As can be seen, the plan is oriented with respect to north. In order to begin construction of the building 400, a construction worker or surveyor must ‘set out’ a number of points of the building 400 on the construction site. For example, the construction worker may initially set out the corners 402a-f of the building 400. This is typically done using a series of stakes or pins hammered into the ground, or using paint or another marker. Once the corners of the building have been set out then the foundations may be dug and concreted, for example.

It is noted that FIG. 4 shows a plan of a building 400 by way of example only. As mentioned previously, exemplary methods and apparatus may be used on any construction project including landscaping projects and the installation of services, such as cabling, pipes and ducting.

In the remainder of this description, setting out of the corners 402a-f of the building 400 will be used as an example of the operation of the methods and apparatus disclosed herein.

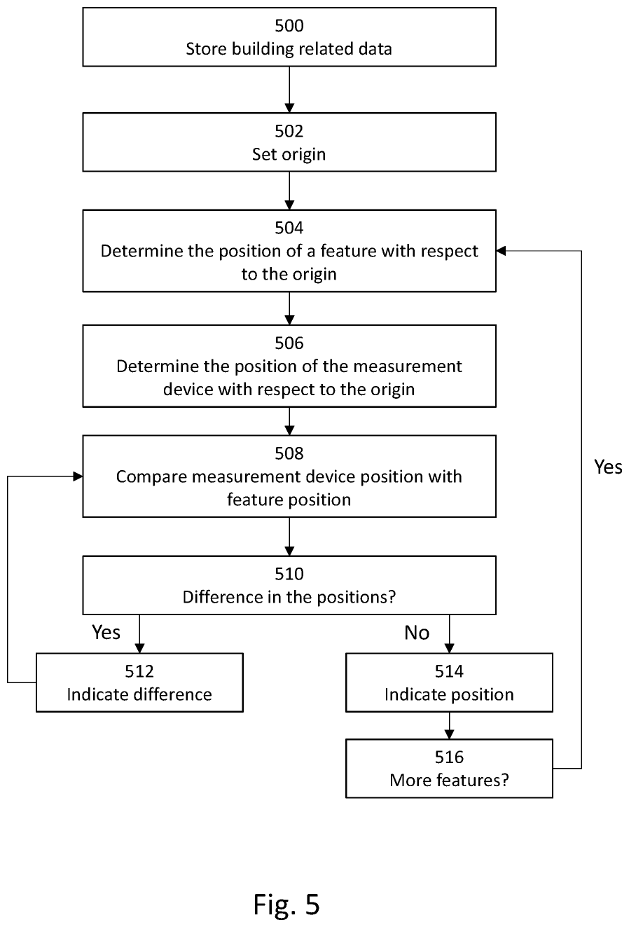

FIG. 5 shows a flow chart of an exemplary method for setting out features of a building 400 on a construction site.

At step 500, building related data is stored in the memory 306 of the processing device 104. The building related data may include the blueprint shown in FIG. 4. In some arrangements, the building related data may include predefined shapes, such as rectangles, circles or partial circles, and arcs. The building related data may be preloaded into the processing device 104 or downloaded from another device, for example over the internet.

At step 502, an origin for the setting out of the property is determined by the origin determiner 316. The measurement device 102 is positioned at a first location on the construction site. The motion sensors 214 of the measurement device obtain position and orientation measurements whilst the measurement device 102 is positioned at the first location.

In exemplary arrangements, the first location on the construction site may be a known location with respect to a coordinate reference system. For example, the first location may be a known location in a local (or engineering) coordinate reference system covering all or part of the construction site. Alternatively or in addition, the first location may be a known location with respect to a geodetic coordinate reference system, a geocentric coordinate reference system and/or a projected coordinate reference system.

The building related data may also be defined in a coordinate reference system, which may be the same coordinate reference system in which the first location is known. This allows the location and/or orientation of the building on the construction site to be determined from the building related data.

In arrangements in which the measurement device 102 and the processing device 104 are separate units, the transmitter 202 of the measurement device 102 transmits data relating to the measurements obtained from the motion sensors 214 (e.g. data identifying the measurements obtained by the motion sensors 214 and/or the measurements themselves) to the processing device 104. In arrangements where the processing device 104 forms part of a single device with the measurement device 102 then external transmission over a medium is not required and the measurements obtained from the motion sensors 214 are passed directly to a computer processor arranged to carry out the functions of the processor 308.

The origin determiner 316 determines the origin to be the location of the measurement device 102 at the first location. In exemplary arrangements, this is done by the position and orientation determiner 314 processing the obtained position and orientation measurements to determine a position and/or orientation of the measurement device 102. For example, if, during an initialisation phase, the position determined from the motion sensors 214 indicates that the measurement device 102 is stationary for longer than a specified period of time, the origin determiner 316 may set the stationary location of the measurement device 102 to be the origin.

Accordingly, the position and/or orientation of the measurement device 102 may be determined using only the motion sensors 214. The motion sensors 214 may comprise linear accelerometers and/or rate gyros. In a specific arrangement, the motion sensors 214 may consist of an inertial measurement unit comprising three linear accelerometers orthogonally aligned along X, Y and Z axes in a body frame, and three rate gyros orthogonally aligned about the same X, Y and Z axes.

Further, the position and/or orientation of the measurement device 102 with respect to one or more features of a structure (in the exemplary case, the building defined by the building related data) may be determined only using measurements obtained by the motion sensors 214. This is done by placing the measurement device 102 at the first location, the spatial relationship of which is known with respect to the building related data.

Referring to FIG. 4, in an example in which the corners of the building 400 are to be set out, a permanent feature within the construction site may be ‘surveyed in’ such that the location of the permanent feature is known within a given coordinate reference system. In some exemplary arrangements, the permanent feature may be a stake or the like that has been hammered into the ground. The surveyed point on the permanent feature may be designated as the first location.

The measurement device 102 may be placed at the surveyed point and a position and/or orientation of the measurement device 102 is determined. The determined position and/or orientation may then be set as the origin. In instances where the position and/or orientation of the measurement device 102 is determined based (optionally solely) on measurements obtained by the motion sensors 214, the determined position and/or orientation may be relative rather than absolute. That is, an initial position and orientation may be given arbitrary values and later position and orientation may be relative to a previous position and orientation.

In some exemplary arrangements, the first location may be determined to be part of an existing structure. For example, the measurement device 102 may first be positioned at a corner 402a of building 400 and this may be determined to be the origin. Further features to be set out may be positioned with reference to the corner 402a.

The processing device 104 may be configured to indicate to the construction worker that the origin has been set, which may optionally be done visually, audibly or haptically. It is noted again that the origin need not be a feature of the building 400 and may be any arbitrary point on the construction site. The origin establishes a local coordinate system that is common to the building related data and the measurement device location, and in which the features of the building 400 may be positioned and oriented. Accordingly, the determined origin may be spatially linked to one or more features of the building 400. For example, the origin may be confirmed as being spatially coincident with a feature of the building, such as the corner 402a. In another example, a distance and direction from the origin to a feature of the building 400, such as the corner 402a, may be known/confirmed. Such confirmations may be provided by a construction worker via the user interface 326.

In exemplary arrangements, the origin determiner 316 may be further configured to set a datum line that extends from the origin in a datum direction. The datum line may be set based on the stored data relating to the building 400. For example, if the corner 402a is set as the origin and the orientation of the building with respect to north is known, the origin determiner 316 may determine a datum line to be coincident with wall 404a or wall 404b, which extend west and south respectively from the corner 402a.

In some exemplary arrangements, the origin determiner 316 may determine the direction of the datum line from the origin 402a based on the construction worker positioning the measurement device 102 at a second location. For example, after determining the origin, the construction worker may place the measurement device at any second location and the origin determiner may determine the datum line to extend from the origin to the second location.

In the same way as before, the processing device 104 may receive the measurements obtained by the motion sensors 214, which are processed by the position and orientation determiner 314. If the measurement device 102 is determined to be stationary for a period of time then the origin determiner 316 may determine the direction of the datum line to be a direction between the origin, e.g. corner 402a, and the second location, e.g. corner 402f. The datum line may therefore be determined to be coincident with the wall 404a. The processing device 104 may be configured to indicate to the construction worker that the datum line has been set, which may optionally be done visually, audibly or haptically.

The origin and/or datum line allow coordinates of the features of the unbuilt building 400 to be determined relative to a local frame of reference set up at the construction site. The local frame of reference allows positioning and orientation of the features of the building 400 relative to the origin. Accordingly, the measurement device may be located within the local coordinate system based on (and optionally using only) motion sensor data.

At step 504. The feature locator 318 determines a location of a feature of the building 400. This is done based on the origin and/or datum line and the stored data relating to the building 400. For example, a feature of a building may be determined with respect to the origin and the datum line using the local frame of reference mentioned above. In addition, the position and/or orientation of the measurement device 102 is known with respect to the origin and the datum line after the measurement device 102 was placed at the first and second locations.

In exemplary arrangements, the construction worker may select a feature to set out using the user interface 326 of the processing device 104. For example, the construction worker may select corner 402b. The feature locator then determines the position of the feature with respect to the origin and/or the datum line (e.g. in the local frame of reference). Alternatively, the next feature to be set out may be determined automatically by the feature locator 318, which then determines the position of the feature with respect to the origin and/or the datum line. In situations where predefined shapes are used, the construction worker may use the interface 326 to input one or more dimensions of the predefined shape, which are then used to determine the position of the feature with respect to the origin and/or the datum line.

At step 506, the position and orientation determiner 314 determines the position of the measurement device 102 in a similar way to that mentioned above. The inertial sensors 214 obtain position and orientation measurements, which are transmitted to the processing device 104 and processed by the position and orientation determiner 314 to determine position and/or orientation of the measurement device 102. In exemplary arrangements, this may be done using only motion sensors 214. The position of the measurement device 102 may then be determined in the local frame of reference at the construction site. When inertial sensors 214 are used, this may be done using a form of dead reckoning positioning from the origin and/or datum line.

At step 508, the comparison engine 320 compares the position of the measurement device 102 with the position of the feature of the building 400 to be set out. If the comparison results in a difference between those two positions, the indication generator 322 generates an indication to the construction worker expressing that difference at step 512. For example, the indication generated may identify a guidance direction that the measurement device must be moved in so as to reach the position of the feature to be set out. In some arrangements, the indication generated may identify a guidance distance from the measurement device 102 to the feature to be set out. The generated indication may be provided visually, audibly or haptically.

After the difference in the position of the measurement device 102 with the position of the feature of the building 400 to be set out has been indicated to the construction worker, the method returns to step 508 and a further comparison is made.

If there is no difference in the position of the measurement device 102 with the position of the feature of the building 400 to be set out (or the difference is within predefined acceptable limits), the indication generator 322 generates, at step 514, an indication that the measurement device 102 is at the position of the feature. Again, this may be provided visually, audibly or haptically.

At step 516, it is determined whether more features of the building 400 are to be set out. If yes then the method returns to step 504 and completes the process for subsequent features.

In exemplary arrangements, the measurement device 102 may include a reference point. The reference point may be a location on the measurement device 102 at which the position of the measurement device 102 is to be calculated. Therefore, the indications generated by the indication generator 322 may indicate a difference (or otherwise) between the position of the reference point and the position of the feature of the building 400 to be set out.

In exemplary arrangements, the measurement device 102 may include no sensors (e.g. cameras, LIDAR etc.) for measuring attributes of the environment external to the measurement device 102, and in one exemplary arrangement may include no further sensors for determining its position and/or orientation. In such arrangements, the position and/or orientation of the measurement device 102 may be determined with respect to the features to be set out because the measurement device 102 has previously been placed at the origin.

This provides the advantage that the invention may be used in environments that have few or no usable visible features (e.g. a field or relatively flat piece of ground), or in environments in which the scene is changing (e.g. busy external environments such as construction sites).

A computer program may be configured to provide any of the above described methods. The computer program may be provided on a computer readable medium. The computer program may be a computer program product. The product may comprise a non-transitory computer usable storage medium. The computer program product may have computer-readable program code embodied in the medium configured to perform the method. The computer program product may be configured to cause at least one processor to perform some or all of the method.

Various methods and apparatus are described herein with reference to block diagrams or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

Computer program instructions may also be stored in a computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/Blu-ray).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks.

Accordingly, the invention may be embodied in hardware and/or in software (including firmware, resident software, micro-code, etc.) that runs on a processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated.

It will be apparent to those skilled in the art that various modifications and variations can be made to the disclosed systems and methods. Other embodiments will be apparent to those skilled in the art from consideration of the specification and practice of the disclosed systems and methods. It is intended that the specification and examples be considered as exemplary only, with a true scope being indicated by the following claims and their equivalents.

1. A system for identifying a location for positioning a feature of an unbuilt and/or unseena structure, the system comprising:
a measuring device including a plurality of motion sensors configured to obtain data representing position and orientation based on rotational and linear movement of the measuring device in a body frame comprising orthogonal x, y and z axes; and
a computer processor configured to:
obtain motion_data from the motion sensors when the measuring device is placed at a first location;
determine, based on the motion data, a position and/or orientation of the measuring device at the first location, and determine an origin point at the first location;
determine, based on stored data relating to the structure, the location for positioning the feature of the structure relative to the origin point;
obtain further motion data from the motion sensors;
determine, based on the further motion data, a further position and/or orientation of the measuring device relative to the origin point;
compare the further position and/or orientation of the measuring device with the determined location for positioning the feature of the structure; and
determine a difference between the further position and/or orientation of the measuring device and the determined location for positioning the feature of the structure.

2. The system according to claim 1, wherein the computer processor is further configured to determine a datum line extending in a datum direction from the origin point, and wherein the location for positioning the feature of the structure is also relative to the datum line.

3. The system according to claim 2, wherein the computer processor is further configured to:
obtain second data from the motion sensors when the measuring device is placed at a second location;
determine, based on the second data, a second position and/or orientation of the measuring device; and
determine the datum direction based on a direction between the second position and the origin point.

4. The system according to claim 1, wherein the computer processor is further configured to:
provide an indication to a user based on the determined difference, the indication comprises a guidance direction indicating a direction from the measuring device to the location for positioning the feature of the structure.

5. The system according to claim 4, wherein the indication comprises a guidance distance indicating a distance from the measuring device to the location for positioning the feature of the structure.

6. The system according to claim 1, wherein the stored data comprises data representing at least a portion of a blueprint of the structure.

7. The system according to claim 1, wherein the stored data indicates one or more predefined shapes, and wherein the computer processor is further configured to receive information regarding one or more dimensions of a predefined shape from a user, and to determine the location for positioning the feature of the structure based on the one or more predefined shapes and the one or more dimensions.

8. The system according to claim 1, further comprising a user interface configured to receive a selection from a user of one of a plurality of features of the structure,
and wherein determining the location for positioning the feature of the structure relative to the origin point is based on the selection.

9. The system according to claim 1, wherein the measuring device is further configured to identify a reference point, and the computer processor is further configured to:
provide an indication based on a difference between the reference point and the location for positioning the feature of the structure.

10. The system according to claim 1, wherein the computer processor is included in a processing device, separate from the measuring device,
and wherein the measuring device comprises a transmitter configured to transmit the obtained data representing position and orientation,
and the processing device comprises a receiver configured to receive the transmitted data.

11. The system according to claim 1, wherein the position of the first location is represented in a coordinate reference system, and wherein the stored data relating to the structure is defined in the coordinate reference system or in a further coordinate reference system that is transformable to the coordinate reference system.

12. The system according to claim 1, wherein the computer processor is configured to determine the position and/or orientation of the measuring device at the first location using only the motion data.

13. The system according to claim 1, wherein the computer processor is configured to determine the further position and/or orientation of the measuring device using only the further motion data.

14. A method of identifying a location for positioning a feature of a structure, the method comprising:
obtaining data from one or more motion sensors that are associated with a measuring device when the measuring device is placed at a first location;
determining, based on stored data relating to the structure, the location for positioning the feature of the structure relative to an origin point;
obtaining further data from the one or more motion sensors;
determining, based on the further data, a position and/or orientation of the measuring device relative to the origin point;
comparing the position and/or orientation of the measuring device with the determined location for positioning the feature of the structure; and
determining a difference between the position and/or orientation of the measuring device and the determined location for positioning the feature of the structure.

15-18. (canceled)

19. The method according to claim 14, further comprising:
determining a datum line extending in a datum direction from the origin point.

20. The method of claim 14, further comprising:
obtaining additional data from the one or more motion sensors when the measuring device is placed at a second location;
determining, based on the additional data, a second position and/or orientation of the measuring device; and
determining a datum direction based on a direction between the second position and/or orientation and the origin point.

21. The method of claim 14, further comprising:
providing an indication to a user based on the determined difference, the indication indicating a direction from the measuring device to the location for positioning the feature of the structure.

22. One or more computer-readable media storing instructions that, when executed by one or more processors, cause the one or more processors to perform operations comprising:
obtaining data from one or more motion sensors that are associated with a measuring device when the measuring device is placed at a first location;
determining, based on stored data relating to a structure, a location for positioning a feature of a structure relative to an origin point;
obtaining further data from the one or more motion sensors;
determining, based on the further data, a position and/or orientation of the measuring device relative to the origin point;
comparing the position and/or orientation of the measuring device with the determined location for positioning the feature of the structure; and
determining a difference between the position and/or orientation of the measuring device and the determined location for positioning the feature of the structure.

23. The one or more computer-readable media of claim 22, wherein the operations further comprise:
obtaining additional data from the one or more motion sensors when the measuring device is placed at a second location;
determining, based on the additional data, a second position and/or orientation of the measuring device; and
determining a datum direction based on a direction between the second position and/or orientation and the origin point.

24. The one or more computer-readable media of claim 22, wherein the operations further comprise:
providing an indication to a user based on the determined difference, the indication indicating a direction from the measuring device to the location for positioning the feature of the structure.
